(19) United States
(12) Patent Application Publication
(10) Pub. No.: US 2018/0115036 A1
(43) Pub. Date: Apr. 26, 2018

(54) FILTER-ANTENNAS FOR RADAR SENSING SYSTEMS AND METHOD FOR PRODUCING A FILTER-ANTENNA

(71) Applicant: NEC CORPORATION, Tokyo (JP)

(72) Inventor: Taras KUSHTA, Tokyo (JP)

(73) Assignee: NEC Corporation, Tokyo (JP)

(21) Appl. No.: 15/558,716

(22) PCT Filed: Mar. 19, 2015
(86) PCT No.: PCT/JP2015/059280

§ 371 Date: Sep. 15, 2017

(51) Int. Cl. H01P 1/208; H01Q 9/04; H01P 3/12

(52) U.S. Cl. CPC H01P 1/2088; H01Q 9/32; H01P 3/121; H01Q 9/045

(57) ABSTRACT

It is an object of the present invention to provide compact filter-antennas disposed in multilayer substrates. A filter-antenna disposed in a multilayer substrate comprising: a radiating element formed as a patch antenna; a resonant element disposed under the radiating element, including a signal via and ground vias surrounding the signal via and functioned as a filter; and a feed transmission line connected to the radiating element.

### TECHNICAL FIELD

The present invention relates to filter-antennas for radar sensing systems and method for producing a filter-antenna.

### BACKGROUND ART

It is a crucial problem in radar sensing systems to receive or to radiate electromagnetic signal in a strictly-defined frequency band. Unwanted signals from neighboring bands allocated near an operation band of a radar system can considerably degrade its electrical performance. Frequency selectivity of the radar antennas is not enough to suppress these signals. Design of a filter in a chip area can improve selectivity of a radar sensing system. However, such filter suffers from low selectivity and high insertion loss.

To overcome these problems, a filter-antenna designed as one combined module can be applied. In the Patent Literature 1, a filter-antenna structure system is proposed. However, cavity resonators, which are basic elements in the filter part of this filter-antenna structure, can have large horizontal dimensions, because resonant conditions are defined by these dimensions.

Thus, it is important to develop such filter-antenna which has compact resonant elements forming the filter part in the filter-antenna structure.

### CITATION LIST

### Patent Literature

[PTL 1] US patent application No. US2012/0293279A1

### SUMMARY OF INVENTION

### Technical Problem

The present invention enables to provide a technique of solving the above-described problem.

### Solution to Problem

One aspect of the present invention provides a filter-antenna disposed in a multilayer substrate comprising: a radiating element formed as a patch antenna; a resonant element disposed under the radiating element, including a signal via and ground vias surrounding the signal via and functioned as a filter; and a feed transmission line connected to the radiating element.

Another aspect of the present invention provides a filter-antenna disposed in a multilayer substrate comprising: a radiating structure serving as an antenna; a plurality of resonant elements, serving as a filter, disposed under the radiating structure; an artificial medium filling in the resonant elements; a feed transmission line connected to the radiating structure; wherein the radiating structure formed as a plurality of patch elements; wherein each of the resonant elements is formed by a signal via and ground vias surrounding the signal via.

Still other aspect of the present invention provides a filter-antenna disposed in a multilayer substrate comprising: a radiating structure serving as an antenna; a plurality of resonant elements, serving as a filter, disposed under the radiating structure; an artificial medium filling in the resonant elements; a feed transmission line; a matching network disposed between the radiating structure and the feed transmission line; wherein the radiating structure formed as a number of patch elements; wherein each of the resonant elements is formed by a signal via and ground vias surrounding the signal via.

Yet other aspect of the present invention provides a method for producing a filter-antenna disposed in a multilayer substrate comprising: forming a radiating element as a patch antenna; disposing a resonant element under the radiating element, including a signal via and ground vias surrounding the signal via and functioned as a filter; and connecting a feed transmission line to the radiating element.

### Advantageous Effects of Invention

According to the present invention, it is possible to provide a filter-antenna which has compact resonant elements forming the filter part in the filter-antenna structure.

### BRIEF DESCRIPTION OF DRAWINGS

FIG. 1A is a top view of a filter-antenna in an exemplary embodiment of the present embodiment.

FIG. 1B is a vertical cross-sectional view of the filter-antenna shown in FIG. 1A on the A-A section.

FIG. 1C is a horizontal cross-sectional view of the filter-antenna shown in FIG. 1B on 1L2, 1L4 and 1L6 conductor layers.

FIG. 1D is a horizontal cross-sectional view of the filter-antenna shown in FIG. 1B on 1L3 and 1L5 conductor layers.

FIG. 1E is a bottom view of the filter-antenna shown in FIG. 1B.

FIG. 2A is a vertical cross-sectional view of the filter-antenna shown in FIG. 1A on A-A section.

FIG. 2B is the vertical cross-sectional view of the filter-antenna shown in FIG. 2A in which a structure between signal and ground vias is replaced by a corresponding homogeneous medium with effective relative permittivity, epsilonₐᵣₜ.

FIG. 2C is the vertical cross-sectional view of the filter-antenna shown in FIG. 2A in which a structure between signal and ground vias is replaced by a homogeneous medium with relative permittivity, epsilon, corresponding the relative permittivity of the substrate isolating material.

FIG. 2D is a graph showing simulated return loss of the filter-antenna shown in FIGS. 2A (FIG. 2B is its physical model).

FIG. 2E is a graph showing simulated return loss of the filter-antenna shown in FIG. 2C.

FIG. 3A is a top view of a filter-antenna in another exemplary embodiment of the present embodiment;

FIG. 3B is a vertical cross-sectional view of the filter-antenna shown in FIG. 3A on A-A section;

FIG. 3C is a horizontal cross-sectional view of the filter-antenna shown in FIG. 3B on 3L2, 3L4 and 3L6 conductor layers;

FIG. 3D is a horizontal cross-sectional view of the filter-antenna shown in FIG. 3B on 3L3 and 3L5 conductor layers;

FIG. 3E is a bottom view of the filter-antenna shown in FIG. 3B.

FIG. 4 is a graph showing simulated return loss of the filter-antenna shown in FIGS. 3A-3E.

FIG. 5A is a top view of a filter-antenna in another exemplary embodiment of the present embodiment;

FIG. 5B is a vertical cross-sectional view of the filter-antenna shown in FIG. 5A on A-A section;

FIG. 5C is a horizontal cross-sectional view of the filter-antenna shown in FIG. 5B on 5L2, 5L4 and 5L6 conductor layers;

FIG. 5D is a horizontal cross-sectional view of the filter-antenna shown in FIG. 5B on 5L3 and 5L5 conductor layers;

FIG. 5E is a bottom view of the filter-antenna shown in FIG. 5B.

FIG. 6A is a top view of a filter-antenna in another exemplary embodiment of the present embodiment;

FIG. 6B is a vertical cross-sectional view of the filter-antenna shown in FIG. 6A on A-A section;

FIG. 6C is a vertical cross-sectional view of the filter-antenna shown in FIG. 6A on B-B section;

FIG. 6D is a horizontal cross-sectional view of the filter-antenna shown in FIG. 6B on 6L2 and 6L4 conductor layers;

FIG. 6E is a horizontal cross-sectional view of the filter-antenna shown in FIG. 6B on 6L3 conductor layer;

FIG. 6F is a bottom view of the filter-antenna shown in FIG. 6B.

FIG. 7A is a top view of a filter-antenna in another exemplary embodiment of the present embodiment;

FIG. 7B is a vertical cross-sectional view of the filter-antenna shown in FIG. 7A on A-A section.

### DESCRIPTION OF EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

It is an object of the present embodiment to provide compact filter-antennas disposed in multilayer substrates. In an aspect of the present embodiment, such compact filter-antennas are provided by the design of a special resonant element used in the filter structure disposed under a radiating element and the resonant length of this resonant element is defined in the vertical direction. Compactness of the resonant element in the vertical direction is provided by an artificial medium of a high permittivity which is disposed between a signal and ground vias forming the resonant element. Mentioned artificial medium is obtained by conductive plates connected to said signal and ground vias and separated from said signal via by a clearance hole and from a ground conductor by an isolating slit.

### First Embodiment

Preferred embodiments of the present embodiment will now be described in detail with reference to the drawings. It should be noted that the relative arrangement of the components, the numerical expressions and numerical values set forth in these embodiments do not limit the scope of the present V unless it is specifically stated otherwise.

Hereinafter, several types of compact filter-antennas disposed in multilayer substrates according to the present embodiment will be described in details with reference to attached drawings. But, it would be well understood that this description should not be viewed as narrowing the appended claims.

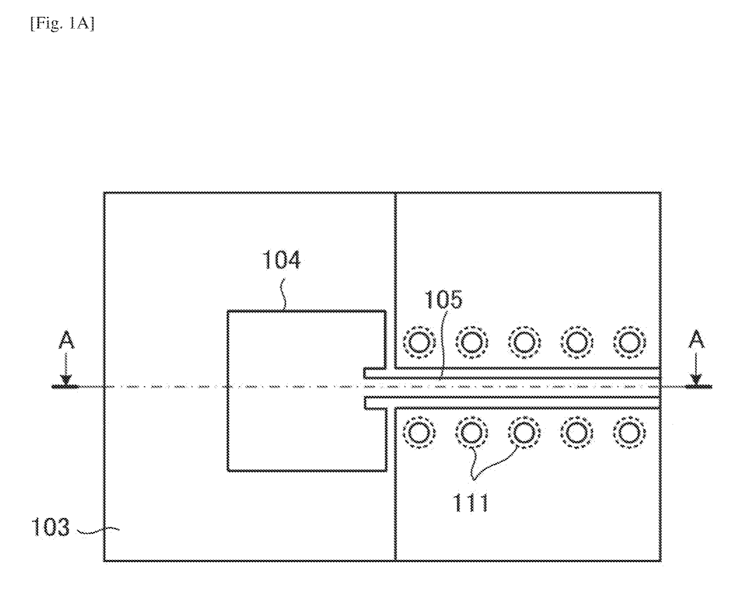

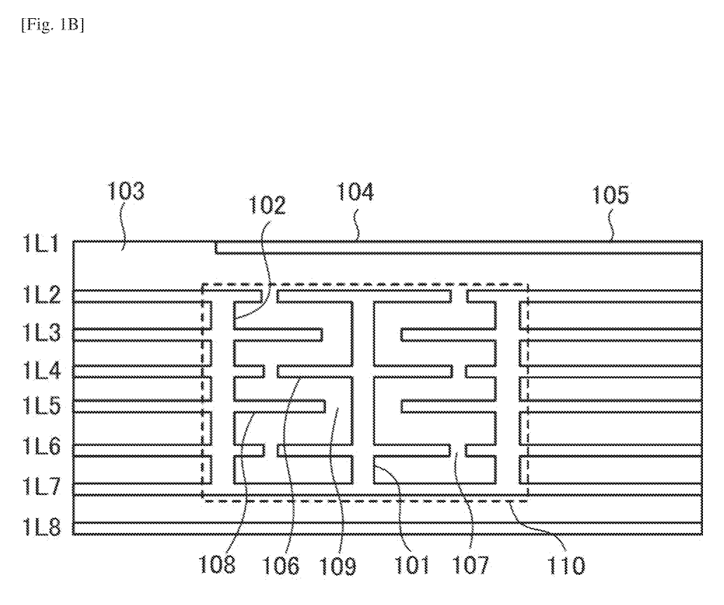

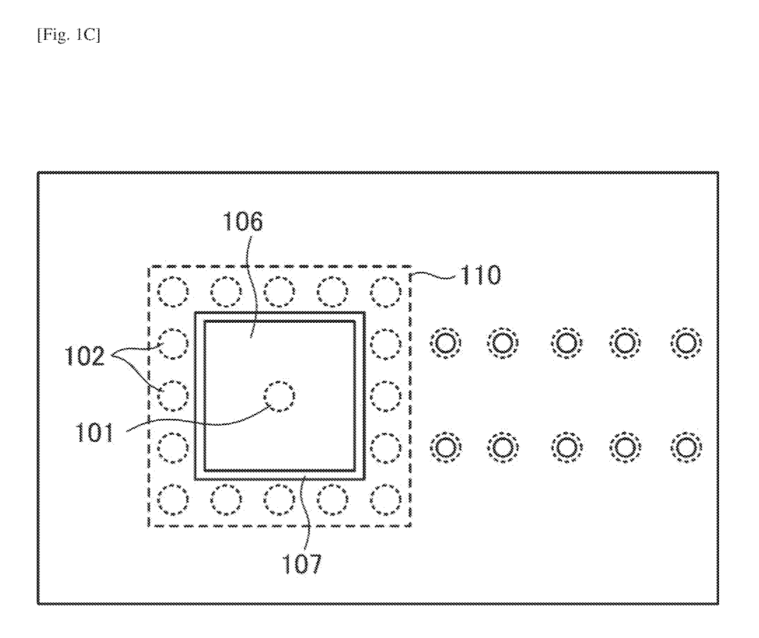

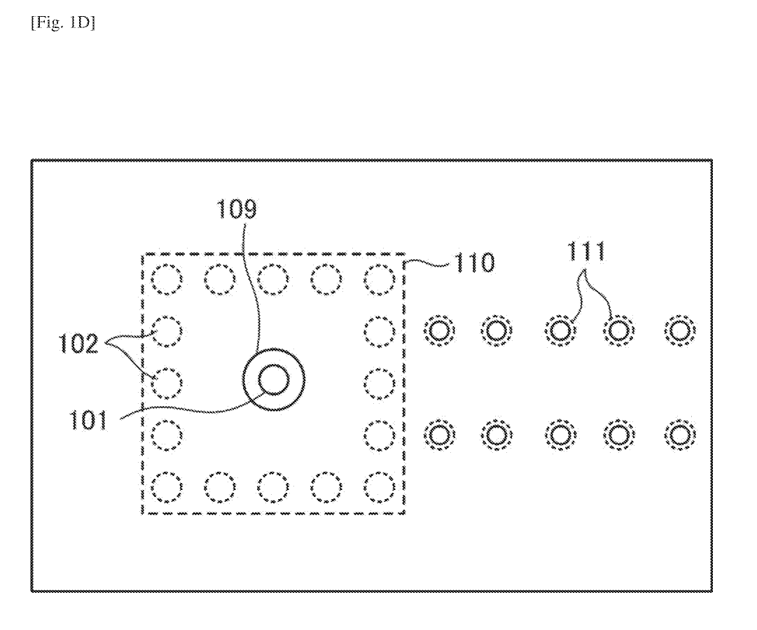

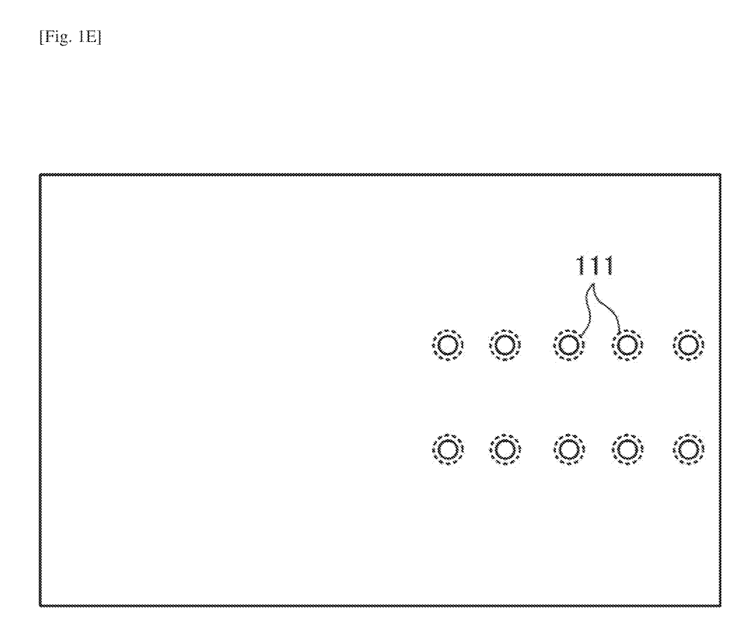

In FIGS. 1A to 1E, an exemplary embodiment of a filter-antenna disposed in a multilayer substrate is shown. This multilayer substrate is provided with a plurality of conductor layers 1L1 to 1L8. Eight conductor layers 1L1 to 1L8 are isolated by a dielectric material 103.

Note this eight conductor layer substrate is only an example of multilayer boards and a number of conductor layers, filling material and other substrate parameters can be different that depends on an application.

In present embodiment, said filter-antenna comprises a radiating element 104, a resonant element 110 designed vertically and providing filtering properties of the filter-antenna structure, and a feed line 105. Said radiating element 104 is formed as a patch connected to said feed line 105. Said resonant element 110 comprises a signal via 101 surrounded by ground vias 102. Such resonant element 110 has low leakage losses and, as a result, a high quality-factor (Q-factor) resonance. Said resonant element 110 is filled in an artificial medium formed by conductor plates 106 connected to said signal via 101 and conductor plates 108 connected to said ground vias 102. Said conductor plates 106 are separated from said ground conductor plates 108 by isolating slits 107, and said ground conductor plates 108 are isolated from said signal via 101 by a clearance hole 109. One end of said feed line 105 is connected to said radiating element 104, while another end of said feed line 105 serves as a terminal for entering signals which have to be radiated or received.

Said artificial medium is arranged between said signal via 101 and said ground vias 102. This artificial medium can be characterized by the effective relative permittivity, epsilon_{eff}, which is dependent on dimensions of conductive plates 106 and 108, isolating slits 107 and clearance holes 109.

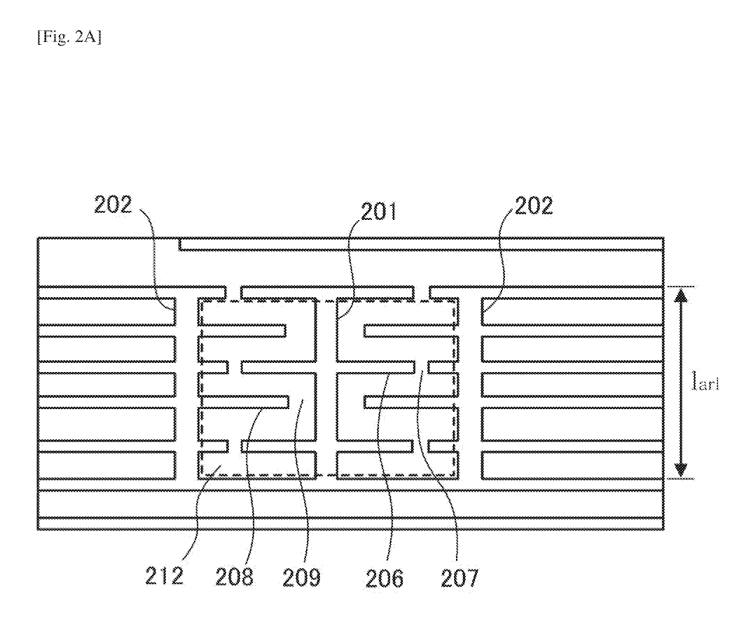

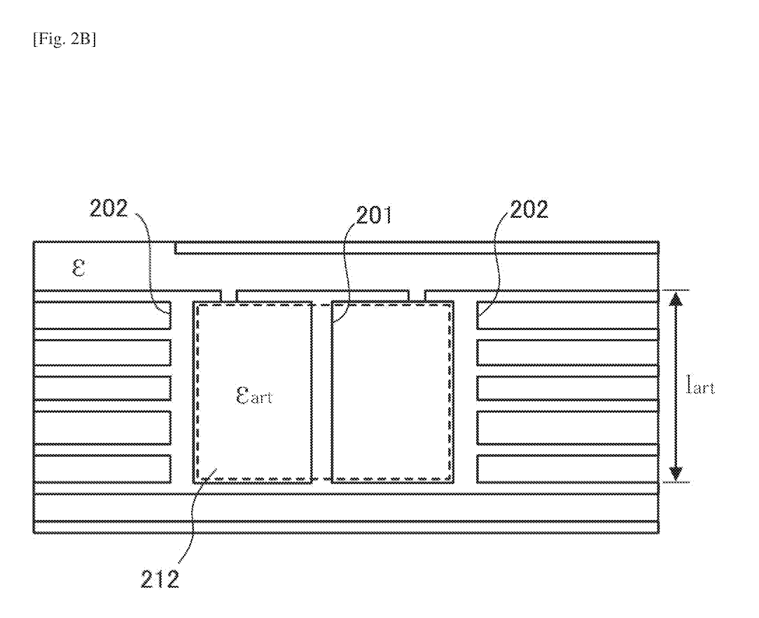

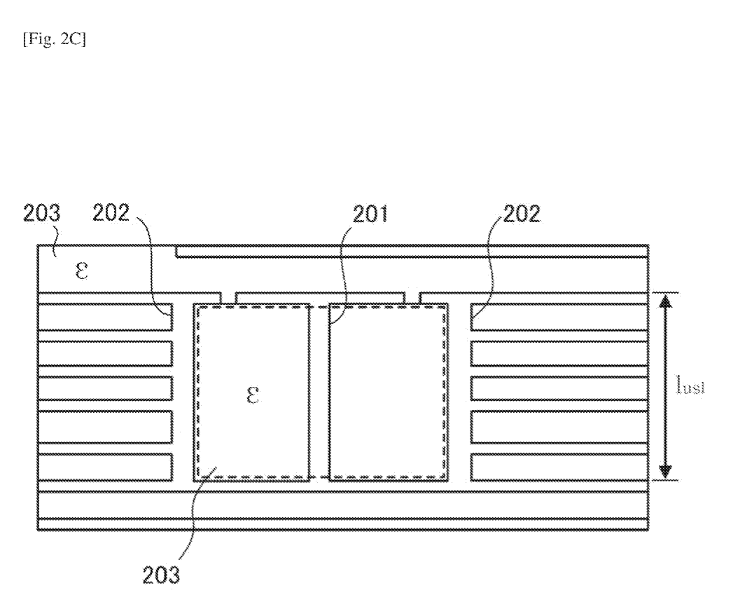

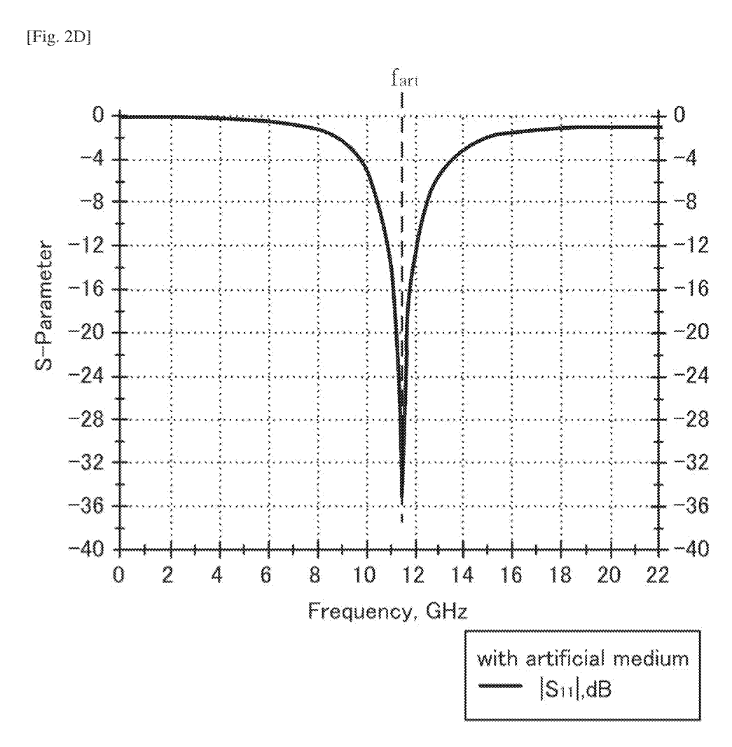

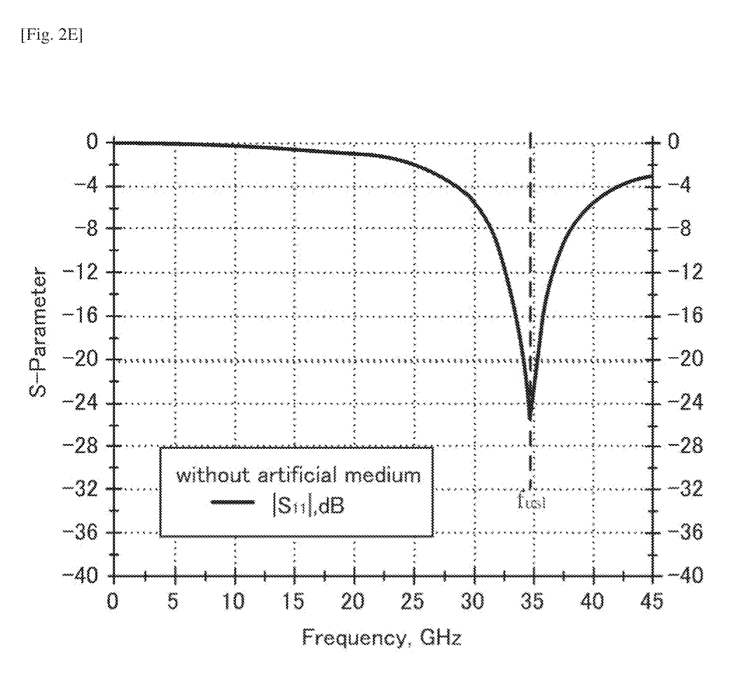

Physical model and numerical data explaining effect of the artificial medium are shown in FIGS. 2A-2E. In FIG. 2A, a resonant element is shown. Said resonant element has a resonant length, lₐᵣₜ, arranged in the vertical direction as demonstrated in FIG. 2A. Artificial medium 212 disposed between signal via 201 and ground vias 202 is formed by conductive plates 206 and 208, isolating slits 207 and clearance holes 209. Said artificial medium 212 can be replaced by a homogeneous material having a relative permittivity, epsilonₐᵣₜ as shown in FIG. 2B. Relative permittivity of such medium 212 can be large in comparison with the relative permittivity of the substrate material. In FIG. 2C, a resonant element formed by signal via 201 and ground vias 202 is shown. In this structure, area between said signal via 201 and ground vias 202 is filled in a substrate isolating material with relative permittivity, epsilon. That is, difference of the structure shown in FIG. 2C is removing the conductive plates forming the artificial medium from the area situated between signal and ground vias. To demonstrate effect of the artificial medium on the resonant properties of the vertical resonant element simulations of structures presented in FIGS. 2A and 2C were carried out. It should be noted that dimensions and isolating materials of the substrates, arrangements and dimensions of the signal and ground vias were the same for structures shown in FIGS. 2A and 2C. Also lᵤₛₗ=lₐᵣₜ (see FIGS. 2A and 2C). In FIG. 2D, simulation data for the resonant element filled in the artificial medium as shown in FIG. 2A is demonstrated. Also, for comparison, the result of simulation of the structure without the artificial medium between signal and ground vias (as shown in FIG. 2C) is are presented in FIG. 2E. As one can in FIGS. 2D and 2E there is a considerable difference in the resonance frequency between the case of the vertical resonant element filled by the artificial medium (fₐᵣₜ is about 11.5 GHz) and the same structure, but with the isolating substrate material only (fᵤₛₗ is about 35 GHz). This variation in the resonant frequency of the vertical resonant element is due the difference in the relative permittivity corresponding structures shown in FIGS. 2A and 2C. In presented cases, the relative permittivity of the substrate isolating material is 3.5 (this value is used in simulation of the structure shown in FIG. 2C). Effective relative permittivity, epsilonₐᵣₜ, for the structure shown in FIG. 2A (FIG. 2B is its physical model) can be estimated according to formula defining the resonances in a transmission line segment as:

$$\begin{matrix}[ Math . 1 ] & \\ {ɛ}_{art} \approx {( \frac{c}{2 \cdot {l}_{art} \cdot {f}_{art}} )}^{2} & ( 1 )\end{matrix}$$

where c is the speed of light; lₐᵣₜ is the length of the vertical element (see FIG. 2A); fₐᵣₜ is the resonance frequency (see FIG. 2D).

As follows from such evaluation the effective relative permittivity of the artificial medium (see FIGS. 2A and 2B) is about 86. It means that artificial medium gives a possibility to form resonant elements with size in the vertical direction much smaller than that of the case of the substrate isolating material.

### Second Embodiment

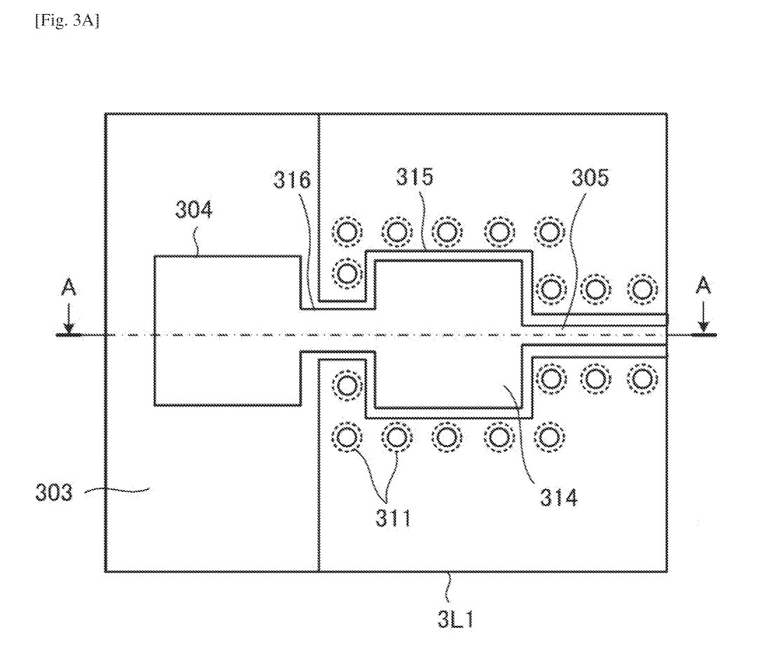

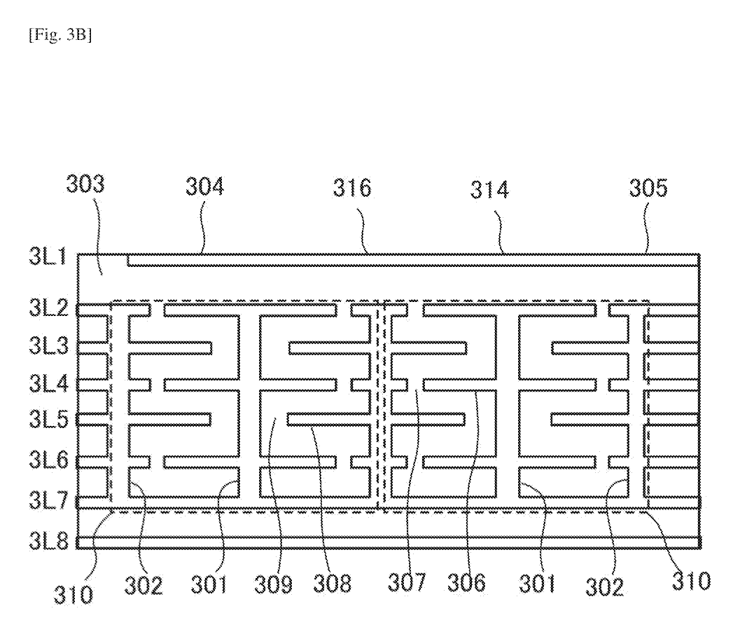

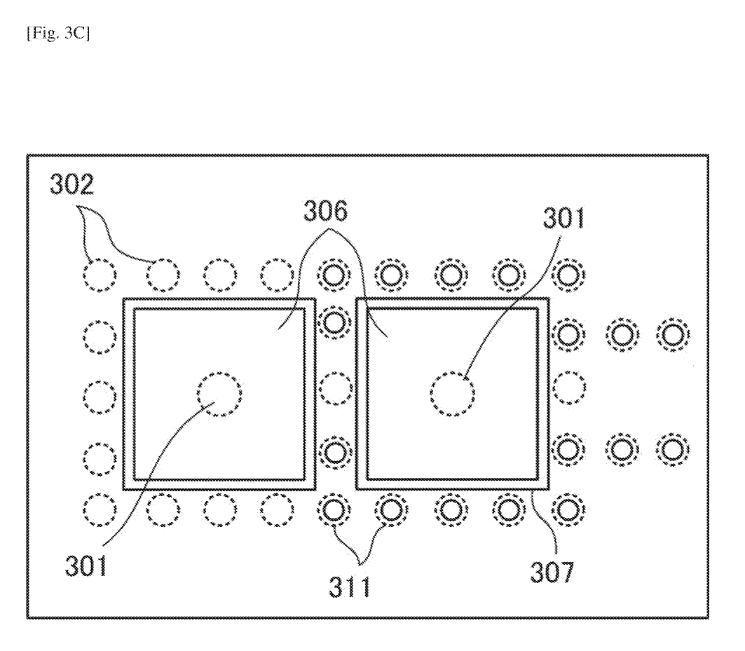

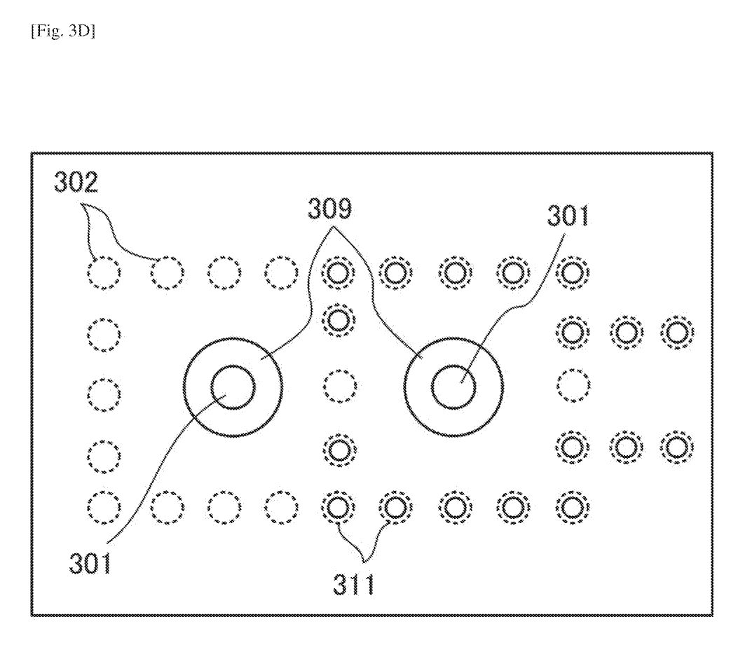

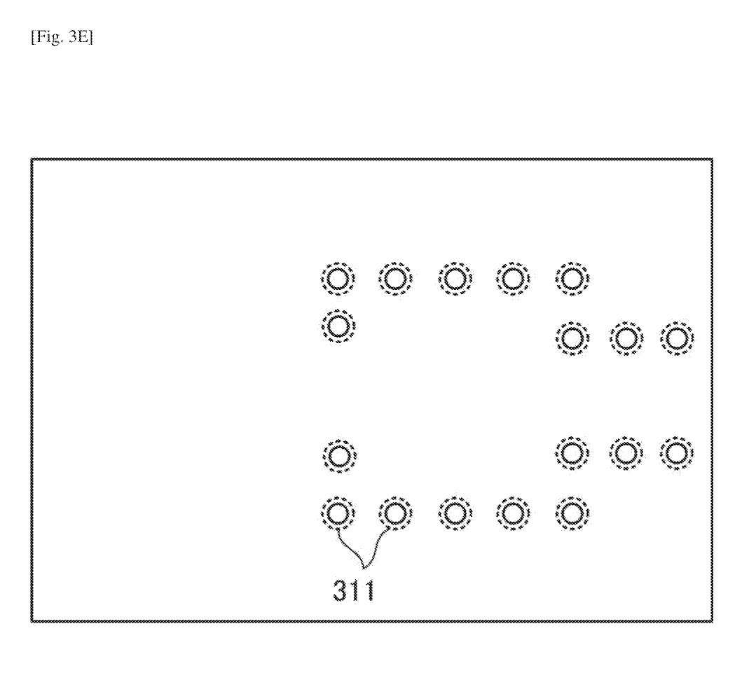

In FIGS. 3A to 3E, another embodiment of the filter-antenna structure disposed in a multilayer substrate is shown. The multilayer substrate is provided with a plurality of conductor layers 3L1 to 3L8. Eight conductor layers 3L1 to 3L8 are isolated by a dielectric material 303.

In present embodiment, said filter-antenna comprises a radiating element 304, two resonant element elements 310 designed vertically and providing filtering in the filter-antenna structure, a matching network comprising a conductor plate 314 connected by means of a strip segment 316 to said radiating element 304 and separated from other conductors at the 3L1 conductor layer by an isolating slit 315, and a feed line 305 connected to said conductor plate 314. Said radiating element 304 is formed as a patch. Said resonant elements 310 comprise a signal via 301 (buried via) surrounded by ground vias 302 (buried vias) and ground vias 311 (through-hole vias). Such resonant element 310 has low leakage losses and, as a result, high Q-factor resonances. Said resonant element 310 is filled in by an artificial medium formed by conductor plates 306 connected to said signal via 301 and conductor plates 308 connected to said ground vias 302. Said conductor plates 306 are separated from said conductor plates 308 by isolating slits 307 and said ground conductor plates 308 are isolated from said signal via 301 by a clearance hole 309. One end of said feed line 305 is connected to said matching network conductor plate which is used for impedance matching between radiating element 304 and said feed line 305. Also another end of said feed line serves as a terminal for entering signals which have to be radiated or received.

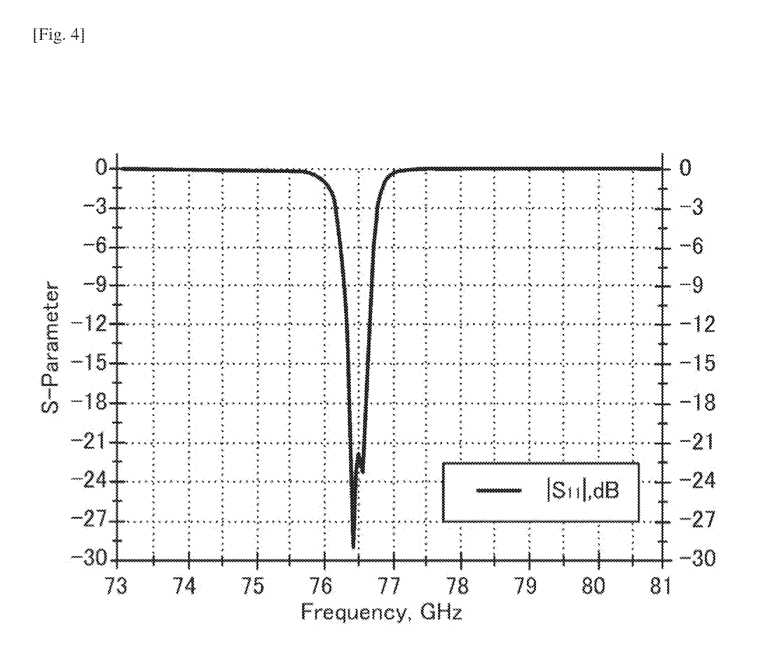

In FIG. 4 simulated data of return losses for filter-antenna structure shown in FIGS. 3A-3E are given. As one can see, presented return loss of the filter-antenna structure shows high-selectivity for signal radiating or receiving.

### Third Embodiment

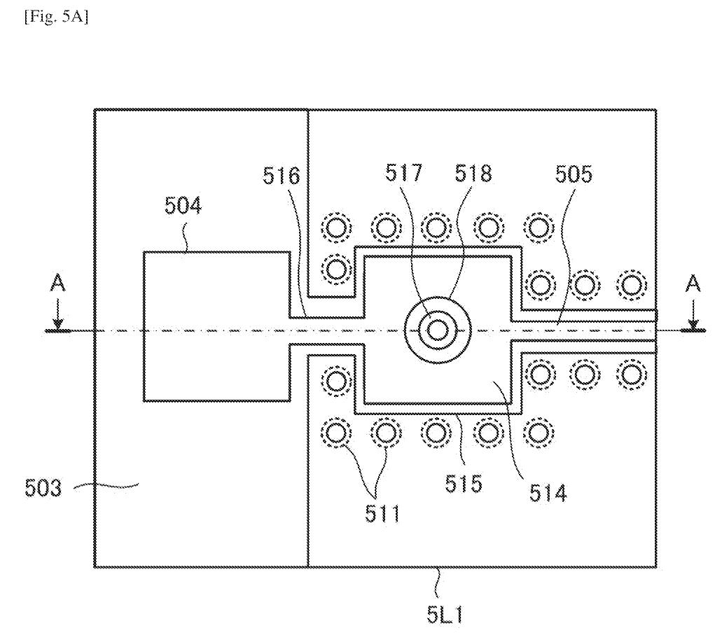

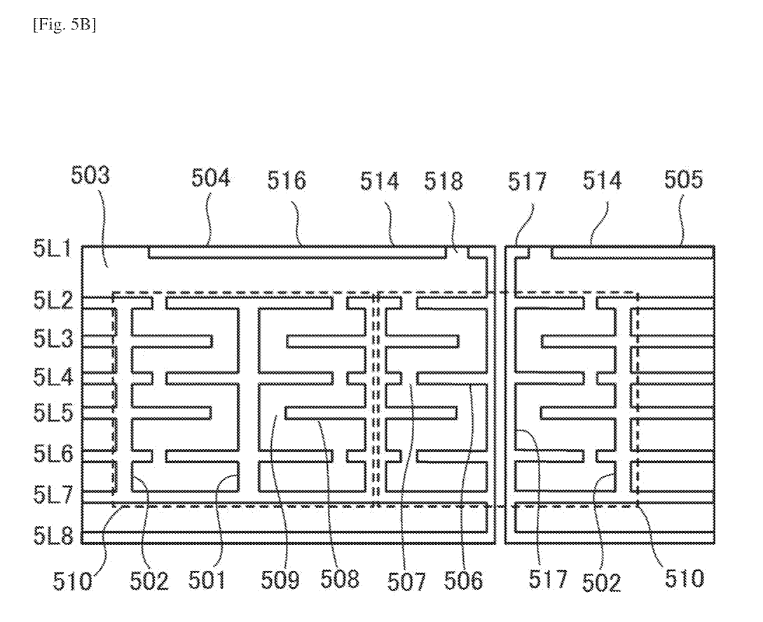

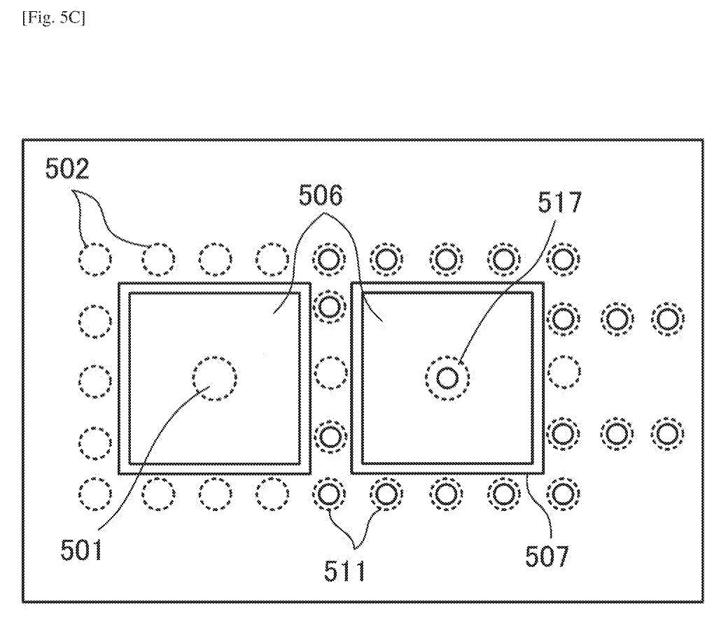

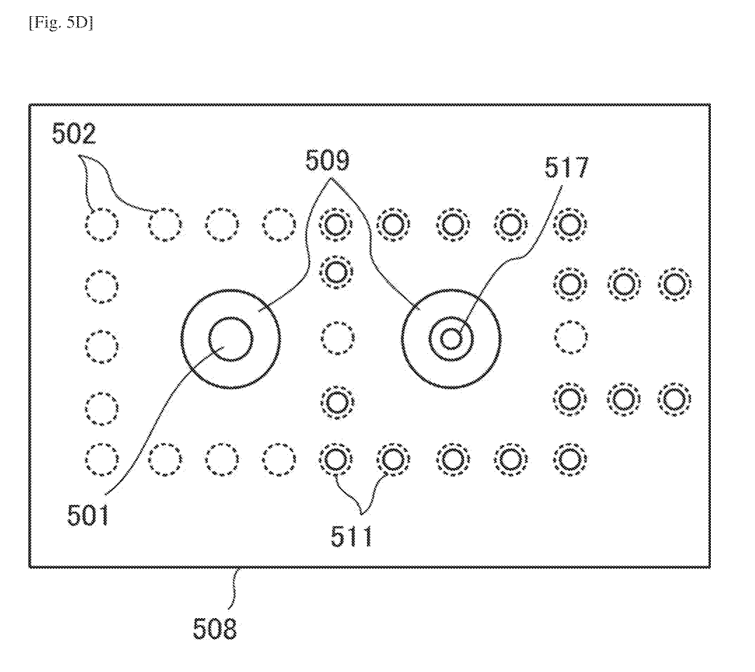

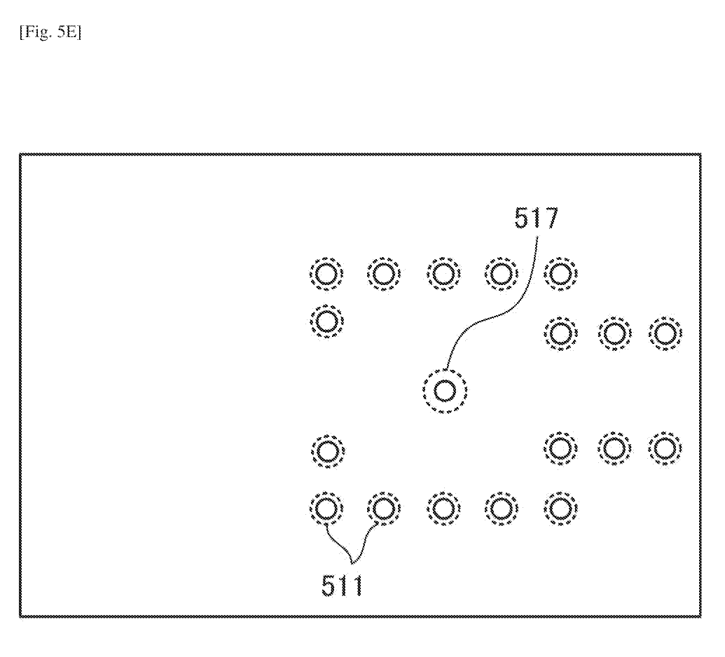

In FIGS. 5A to 5E, another embodiment of the filter-antenna structure disposed in a multilayer substrate is shown. The multilayer substrate is provided with a plurality of conductor layers 5L1 to 5L8. Eight conductor layers 5L1 to 5L8 are isolated by a dielectric material 503.

In present embodiment, said filter-antenna comprises a radiating element 504, two resonant element elements 510 designed vertically and providing improved filtering in the filter-antenna structure, a matching network comprising a conductor plate 514 connected by means of a strip segment 516 to said radiating element 504 and separated from other conductors at the 5L1 conductor layer by an isolating slit 515, and a feed line 505 connected to said conductor plate 514. Said radiating element 504 is formed as a patch. The first of said resonant elements 510 comprises a signal via 501 surrounded by ground vias 502 and the second of said resonant elements comprises a signal via 517 surrounded by ground vias 511. In said resonant elements 510, the first one is formed by buried vias and the second resonant element is obtained by through-hole vias. Said signal via 517 is separated from said conductor plate 514 of said matching network by a clearance hole 518. Dimensions of said clearance hole 518 can be to control impedance in said matching network. Such resonant elements 510 have low leakage losses and, as a result, high Q-factor resonances. Said resonant element 510 is filled in by an artificial medium formed by conductor plates 506 connected to said signal via 501 and conductor plates 508 connected to said ground vias 502. Said conductor plates 506 are separated from said ground conductor plates 508 by isolating slits 507 and said conductor plates 508 are isolated from said signal via 501 by a clearance hole 509. One end of said feed line 505 is connected to said matching network conductor plate 514 which is used for impedance matching radiating element 504 and said feed line 505. Also another end of said feed line serves as a terminal for entering signals which have to be radiated or received.

### Fourth Embodiment

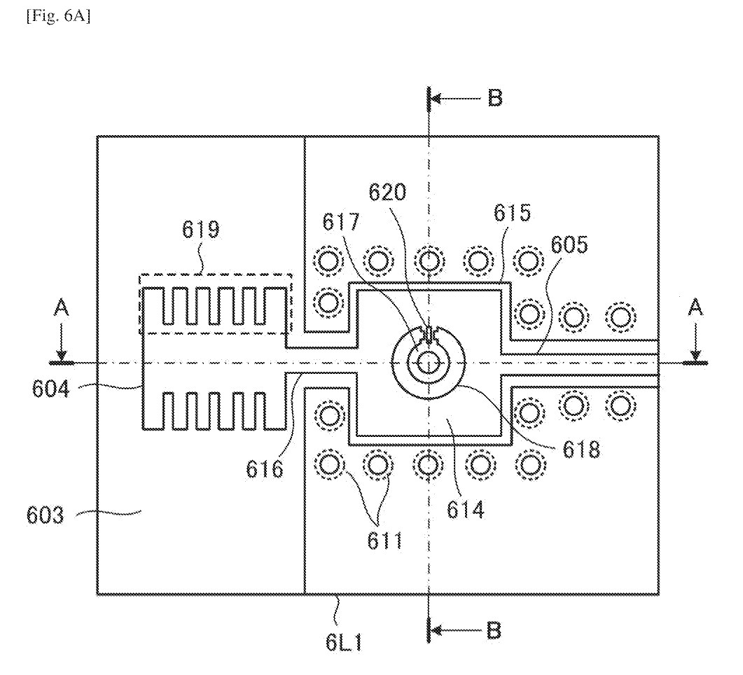

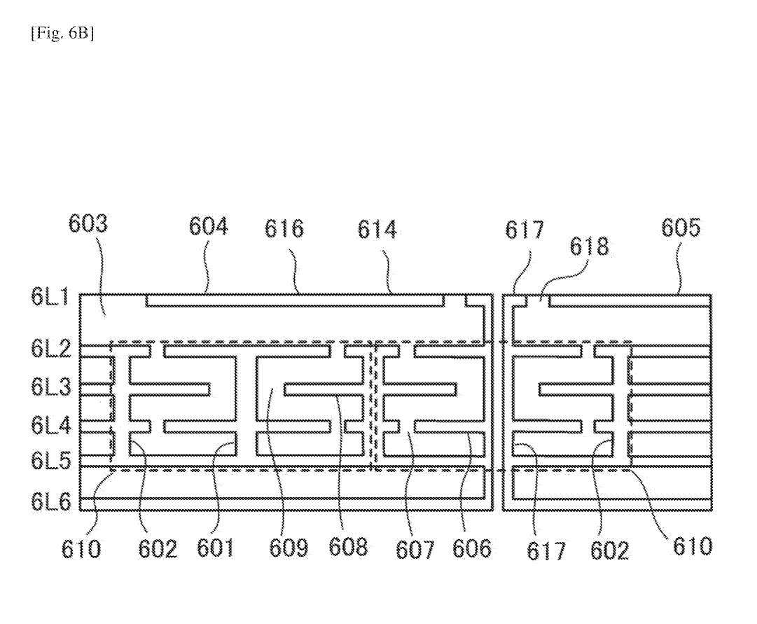

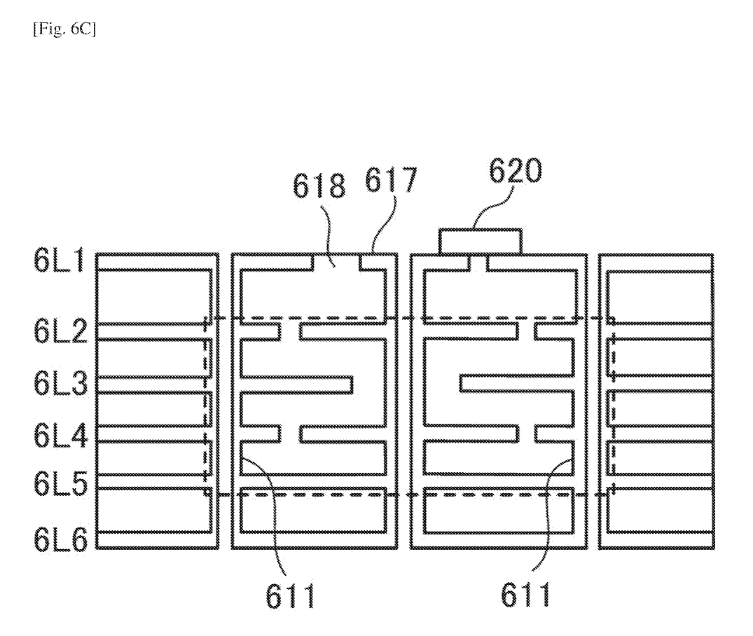

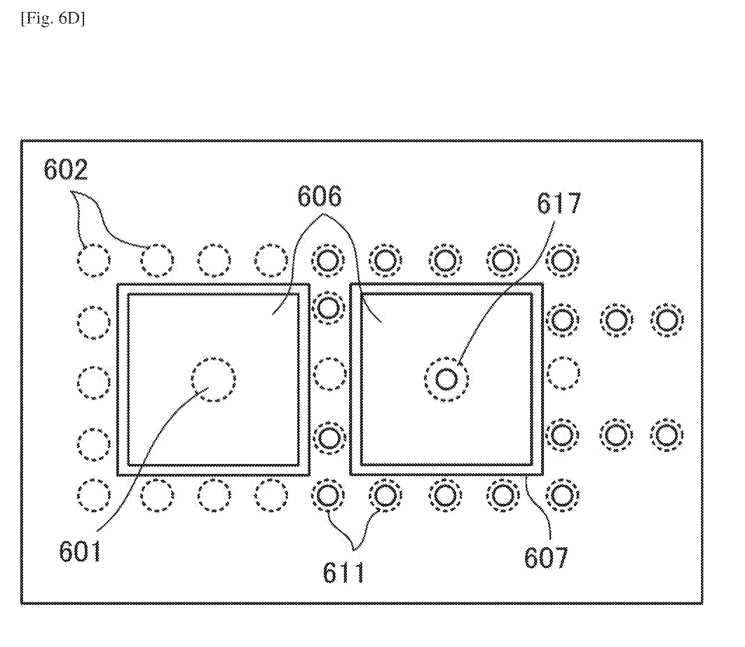

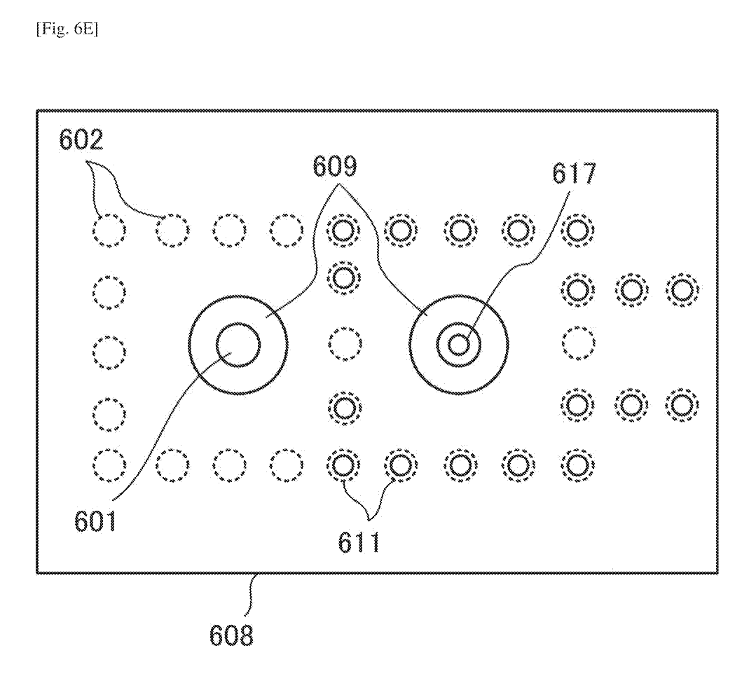

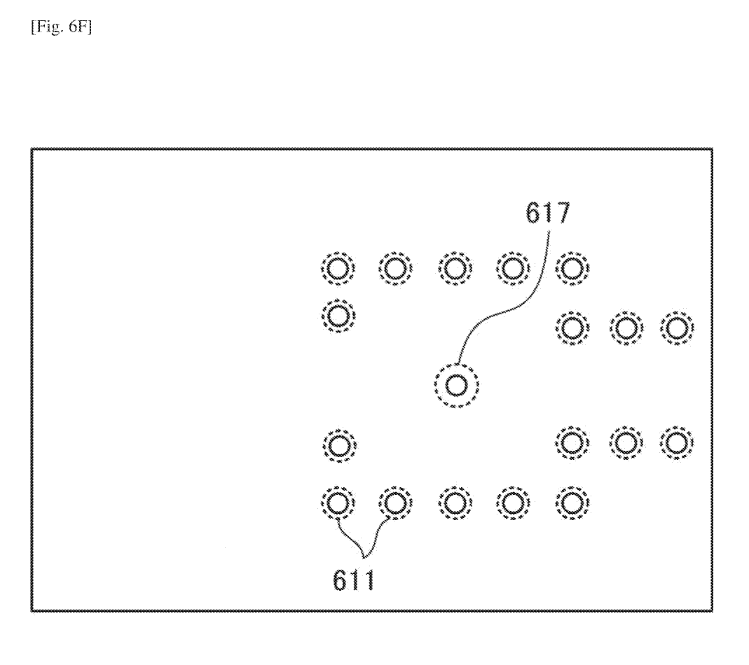

In FIGS. 6A to 6F, another embodiment of the filter-antenna structure disposed in a multilayer substrate is shown. The multilayer substrate is provided with a plurality of conductor layers 6L1 to 6L6. Six conductor layers 6L1 to 6L6 are isolated by an isolating material 603.

In present embodiment, said filter-antenna comprises a radiating element 604, two resonant element elements 610 designed vertically and providing filtering characteristics of the filter-antenna structure, a matching network comprising a conductor plate 614 connected by means of a strip segment 616 to said radiating element 604 and separated from other conductors at the 6L1 conductor layer by an isolating slit 615, and a feed line 605 connected to said conductor plate 614. Said radiating element 604 is formed as a patch. This patch has corrugation 619 used to widen an operation band of said filter-antenna. The first of said resonant elements 610 comprises a signal via 601 surrounded by ground vias 602 and the second of said resonant elements comprises a signal via 617 surrounded by ground vias 611. In said resonant elements 610, the first one is formed by buried vias and the second resonant element is obtained by through-hole vias. Said signal via 617 is separated from said conductor plate 614 of said matching network by a clearance hole 618. Also, for providing a control of the characteristic impedance of said matching network a tunable element 620 connected a pad of said signal via 617 and said conductor plate 614 is used. Said tunable element 620 can be formed using a variable capacitor or a variable inductor. Said resonant element 610 is filled in by an artificial medium formed by conductor plates 606 connected to said signal via 601 and conductor plates 608 connected to said ground vias 602. Said conductor plates 606 are separated from said ground conductor plates 608 by isolating slits 607 and said conductor plates 608 are isolated from said signal via 601 by a clearance hole 609. One end of said feed line 605 is connected to said matching network conductor plate 614 which is used for impedance matching of said radiating element 604 and said feed line 605. Also, another end of said feed line 605 serves as a terminal for entering signals which have to be radiated or received.

### Fifth Embodiment

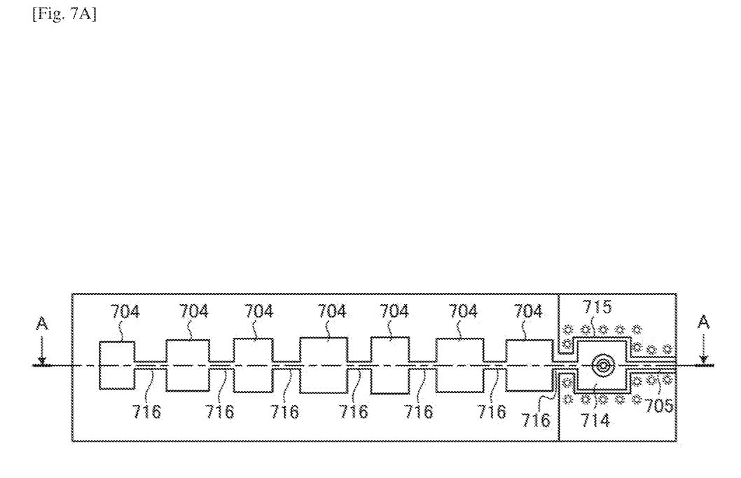

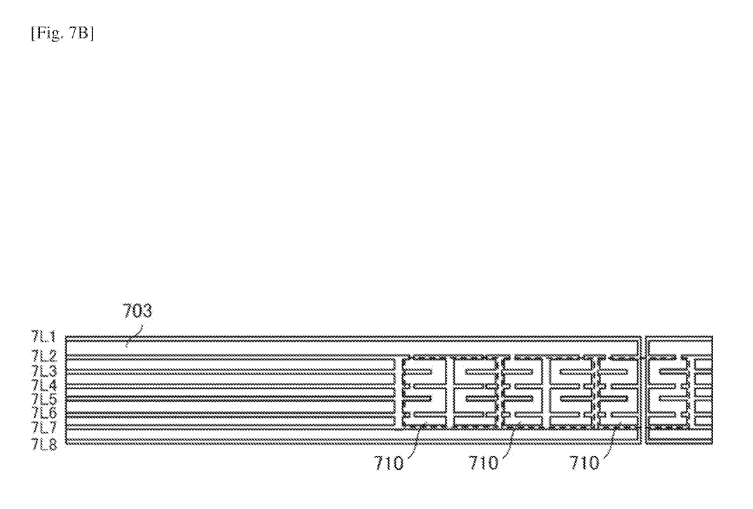

In FIGS. 7A to 7B, another embodiment of the filter-antenna structure disposed in a multilayer substrate is shown. The multilayer substrate is provided with a plurality of conductor layers 7L1 to 7L8. Eight conductor layers 7L1 to 7L8 are isolated by a dielectric material 703.

In present embodiment, said filter-antenna structure is formed as an array. Said array comprises seven radiating elements 704 connected by strip segments 716. A filtering part in said filter-antenna structure is obtained by three resonant elements 710. Each of said radiating elements 710 is designed vertically and filled in an artificial medium formed by conductor plates connected to signal vias, ground conductor plates connected to ground vias, where said conductor plates are separated from said ground conductor plates by isolating slits and said ground conductor plates are isolated from said signal vias by clearance holes. For impedance matching of said radiating elements 704 and a feed line 705, a matching network comprising a conductor plate 714 (separated from other conductors by an isolating slit 715) is applied. One end of said feed line 705 is connected to said matching network conductor plate 714 and another end of said feed line 705 serves as a terminal for entering signals which have to be radiated or received.

### Other Embodiments

While the present invention has been described in relation to some exemplary embodiments, it is to be understood that these exemplary embodiments are for the purpose of description by example, and not of limitation. While it will be obvious to those skilled in the art upon reading the present specification that various changes and substitutions may be easily made by equal components and art, it is obvious that such changes and substitutions lie within the true scope and spirit of the presented invention as defined by the claims.

### Other Exemplaryer Embodiments

Some or all of the above-described embodiments can also be described as in the following further exemplary embodiments, but are not limited to the followings.

### Further Exemplary Embodiment 1

A filter-antenna disposed in a multilayer substrate comprising:

a radiating element formed as a patch antenna;

a resonant element disposed under said radiating element, including a signal via and ground vias surrounding said signal via and functioned as a filter; and

a feed transmission line connected to said radiating element.

### Further Exemplary Embodiment 2

The filter-antenna according to further exemplary embodiment 1 wherein said artificial material is disposed between said signal via and said ground vias and formed by conductor plates connected to said signal via and isolated from ground conductors by isolating slits and conductor plates connected to ground vias and isolated from said signal via by clearance holes.

### Further Exemplary Embodiment 3

The filter-antenna according to further exemplary embodiment 2 wherein each of said patch in said radiating element has corrugated edges.

### Further Exemplary Embodiment 4

A filter-antenna disposed in a multilayer substrate comprising:

a radiating structure serving as an antenna;

a plurality of resonant elements, serving as a filter, disposed under said radiating structure;

an artificial medium filling in said resonant elements;

a feed transmission line connected to said radiating structure;

wherein said radiating structure formed as a plurality of patch elements;

wherein each of said resonant elements is formed by a signal via and ground vias surrounding said signal via.

### Further Exemplary Embodiment 5

The filter-antenna according to further exemplary embodiment 4 wherein said artificial material is formed by conductor plates connected to said signal via and isolated from ground conductors by isolating slits and conductor plates connected to said ground vias and isolated from said signal via by clearance holes.

### Further Exemplary Embodiment 6

The filter-antenna according to further exemplary embodiment 5 wherein said each of said patch elements has corrugated edges.

### Further Exemplary Embodiment 7

A filter-antenna disposed in a multilayer substrate comprising:

a radiating structure serving as an antenna;

a plurality of resonant elements, serving as a filter, disposed under said radiating structure;

an artificial medium filling in said resonant elements;

a feed transmission line;

a matching network disposed between said radiating structure and said feed transmission line;

wherein said radiating structure formed as a number of patch elements;

wherein each of said resonant elements is formed by a signal via and ground vias surrounding said signal via.

### Further Exemplary Embodiment 8

The filter-antenna according to further exemplary embodiment 7 wherein said matching network comprises a conductor plate connected to said radiating structure and said feed transmission line and separated from other conductors by isolating slits.

### Further Exemplary Embodiment 9

A method for producing a filter-antenna disposed in a multilayer substrate comprising:

forming a radiating element as a patch antenna;

disposing a resonant element under said radiating element, including a signal via and ground vias surrounding said signal via and functioned as a filter; and

connecting a feed transmission line to said radiating element.

What is claimed is:

1. A filter-antenna disposed in a multilayer substrate comprising:
a radiating element formed as a patch antenna;
a resonant element disposed under said radiating element, including a signal via and ground vias surrounding said signal via and functioned as a filter; and
a feed transmission line connected to said radiating element.

2. The filter-antenna according to claim 1 wherein said artificial material is disposed between said signal via and said ground vias and formed by conductor plates connected to said signal via and isolated from ground conductors by isolating slits and conductor plates connected to ground vias and isolated from said signal via by clearance holes.

3. The filter-antenna according to claim 2 wherein each of said patch in said radiating element has corrugated edges.

4. A filter-antenna disposed in a multilayer substrate comprising:
a radiating structure serving as an antenna;
a plurality of resonant elements, serving as a filter, disposed under said radiating structure;
an artificial medium filling in said resonant elements;
a feed transmission line connected to said radiating structure;
wherein said radiating structure formed as a plurality of patch elements;
wherein each of said resonant elements is formed by a signal via and ground vias surrounding said signal via.

5. The filter-antenna according to claim 4 wherein said artificial material is formed by conductor plates connected to said signal via and isolated from ground conductors by isolating slits and conductor plates connected to said ground vias and isolated from said signal via by clearance holes.

6. The filter-antenna according to claim 5 wherein said each of said patch elements has corrugated edges.

7. A filter-antenna disposed in a multilayer substrate comprising:
a radiating structure serving as an antenna;
a plurality of resonant elements, serving as a filter, disposed under said radiating structure;
an artificial medium filling in said resonant elements;
a feed transmission line;
a matching network disposed between said radiating structure and said feed transmission line;
wherein said radiating structure formed as a number of patch elements;
wherein each of said resonant elements is formed by a signal via and ground vias surrounding said signal via.

8. The filter-antenna according to claim 7 wherein said matching network comprises a conductor plate connected to said radiating structure and said feed transmission line and separated from other conductors by isolating slits.

9. (canceled)
